(19) United States
(12) Patent Application Publication
(10) Pub. No.: US 2026/0141451 A1
(43) Pub. Date: May 21, 2026

(54) METHOD OF DETERMINING COLLATERAL RATIO FOR LIQUIDITY RISK MANAGEMENT OF SECURITY TOKEN OPERATING INVESTMENT PRODUCTS, COMPUTING DEVICE FOR PERFORMING THE SAME, AND RECORDING MEDIUM

(71) Applicant: OneCup Co., Ltd., Seongnam-si (KR)

(72) Inventors: Sojung CHOI, Seongnam-si (KR); Seunghwan LEE, Seongnam-si (KR); Hanyeong KO, Seongnam-si (KR); Taehyun KANG, Seongnam-si (KR); Sang Bum HUR, Seongnam-si (KR)

(73) Assignee: OneCup Co., Ltd., Seongnam-si (KR)

(21) Appl. No.: 19/222,437

(22) Filed: May 29, 2025

(30) Foreign Application Priority Data
Nov. 20, 2024 (KR) 10-2024-0165757

(51) Int. Cl. G06Q 40/06

(52) U.S. Cl. CPC G06Q 40/06

(57) ABSTRACT

Disclosed are a method, device, and recording medium for determining a collateral ratio for liquidity risk management of a security token offering (STO) investment product. The method of determining a collateral ratio for liquidity risk management of STO investment product according to various embodiments of the present disclosure includes collecting data related to an STO investment product; determining an asset liquidity risk of the investment product based on the collected data; and determining the collateral ratio for the investment product based on the determined asset liquidity risk.

### CROSS-REFERENCE TO RELATED APPLICATION

This application claims priority to and the benefit of Korean Patent Application No. 2024-0165757, filed on Nov. 20, 2024, the disclosure of which is incorporated herein by reference in its entirety.

### BACKGROUND

### 1. Field of the Invention

Various embodiments of the present disclosure relate to a method of determining a collateral ratio for liquidity risk management of a security token offering investment product, a device, and a recording medium.

### 2. Discussion of Related Art

A security token offering (STO) system provides an asset management method that is differentiated from the existing financial method by digitizing real assets and allowing the digitized real assets to be traded on the blockchain.

The STO provides liquidity through tokenization based on traditional assets such as stocks, real estate, and bonds, and supports investors to access the assets more easily. However, there is a possibility that the liquidity and convertibility risk of assets may arise in such an STO system.

In particular, a difference in liquidity exists depending on the type of real assets, and when assets owned by third parties are brokered, mass selling by investors may occur, which may increase the convertibility risk of the assets due to the lack of the liquidity.

In addition, the existing STO system has limitations in efficiently managing such liquidity risks, which may cause problems with investor protection.

In addition, the existing STO system does not reflect the difference in risk between the asset types by setting a uniform collateral ratio. When the risk of a specific asset is not properly managed, investors may not be adequately protected. This may not only have a negative impact on the confidence of investors but may also have a negative impact on the stability of the STO system.

In addition, an account integration management method does not separate risks between assets, and problems with one asset may affect the entire system. For example, the lack of liquidity in a specific asset may negatively impact the overall liquidity of the system and potentially spread to other assets.

The background technology described above is something that the inventor has possessed or acquired in the process of deriving the content of this disclosure, and it cannot necessarily be said to be publicly disclosed prior to this application.

### SUMMARY OF THE INVENTION

The present disclosure seeks to solve is to resolve the problems of the conventional security token offering (STO) system described above, and is directed to providing a method, device, and recording medium for determining a collateral ratio for liquidity risk management of an STO investment product, through which data related to STO investment product is analyzed to determine an asset liquidity risk of the investment products, the collateral ratio for the investment product is dynamically determined and adjusted based on the determination to prevent liquidity problems that may occur when investors request mass selling, investors manage the risk of their investment assets more clearly to enable relatively safe investment, and the liquidity risk of the STO investment product is effectively managed to more efficiently perform the overall asset management.

The problems to be solved by the present disclosure are not limited to the above-described problems, and other problems that are not described may be obviously understood by those skilled in the art from the following description.

According to an aspect of the present invention, there is provided a method of determining a collateral ratio for liquidity risk management of an STO investment product, which is performed by a computing device, including collecting data related to the STO investment product, determining an asset liquidity risk of the investment products based on the collected data, and determining the collateral ratio for the investment products based on the determined asset liquidity risk.

The determining of the asset liquidity risk may include calculating a plurality of risk indicators based on the collected data, and calculating a risk score as the asset liquidity risk based on the plurality of calculated risk indicators.

The plurality of calculated risk indicators may include at least one of a market liquidity risk indicator (L1), an asset liquidity risk indicator (L2), a credit risk indicator (CR), a market volatility risk indicator (V), a regulatory risk indicator (RR), a macroeconomic risk indicator (MR), a correlation risk indicator (Corr), and an event risk indicator (ER).

The calculating of the risk score may include setting weights corresponding to each of the plurality of calculated risk indicators, assigning the set weights to each of the plurality of calculated risk indicators, and calculating the risk score by summing the plurality of risk indicators to which the weights are assigned.

The setting of the weights may include setting importance corresponding to each of the plurality of risk indicators calculated based on a type of the investment products and an owner of the investment products, and setting the weights corresponding to each of the plurality of calculated risk indicators based on the set importance.

The determining of the collateral ratio may include determining the collateral ratio using the following Equation 1.

$$Collateral Ratio ( CR ) = α \cdot In ( R + 1 ) + β \qquad < Equation 1 >$$

Here, the α may indicate a first constant value set in advance and determine a range of change in the collateral ratio according to a change in the risk score, the β may indicate a second constant value set in advance and determine a basic collateral ratio, and the R may indicate the calculated risk score.

The determining of the collateral ratio may include determining the collateral ratio for the investment product based on a minimum collateral ratio and a maximum collateral ratio set in advance, the minimum collateral ratio may be determined based on at least one of regulatory requirements, asset type-specific characteristics, market practices, industry standards, and risk management strategies, and the maximum collateral ratio may be determined based on at least one of investor burden, transaction activation strategy, systemic risk prevention strategy, regulation, and legal restriction.

The method may further include updating a smart contract that issues, trades, and manages the STO in the investment product according to the determined collateral ratio, and providing a notification corresponding to the determined collateral ratio and the updated smart contract.

The method may further include allocating an asset of a liquidity pool to the investment product based on the determined collateral ratio, in which the liquidity pool may be a pool composed of funds deposited from operating companies of a plurality of STO investment products, investors of the plurality of STO investment products, and a professional liquidity provider for the purpose of hedging the liquidity risk.

The allocating of the asset of the liquidity pool to the investment products may include determining an asset size to be allocated to the investment product based on a transaction size of the investment product, correcting the determined asset size based on the determined collateral ratio, and allocating the asset of the liquidity pool equivalent to the corrected asset size to the investment product in response to the asset liquidity risk of the investment products.

The allocating of the asset of the liquidity pool to the investment products may include allocating, to the investment product, the asset of the liquidity pool equivalent to the size of the asset proportional to the determined collateral ratio at a predetermined ratio.

According to another aspect of the present invention, there is provided a computing device for performing a method of determining a collateral ratio for liquidity risk management of STO investment products, including a processor, a network interface, a memory, and a computer program loaded into the memory and executed by the processor, in which the computer program includes an instruction to collect data related to the STO investment products, an instruction to determine an asset liquidity risk of the investment products based on the collected data, and an instruction to determine the collateral ratio for the investment products based on the determined asset liquidity risk.

According to still another aspect of the present invention, there is provided a computer-readable recording medium on which a computer program is recorded, wherein the computer program is coupled to a computing device to execute a method of determining a collateral ratio for liquidity risk management of an STO investment product, which includes collecting data related to the STO investment products, determining an asset liquidity risk of the investment product based on the collected data, and determining the collateral ratio for the investment product based on the determined asset liquidity risk.

Other detailed contents of the present disclosure are described in a detailed description and are illustrated in the drawings.

### BRIEF DESCRIPTION OF DRAWINGS

The following drawings attached to this specification illustrate preferred embodiments of the present disclosure and serve to further understand the technical idea of the present disclosure along with the detailed description of the above-described invention. Therefore, the present disclosure should not be construed as limited to the matters shown in such drawings:

FIG. 1 is a diagram illustrating a system for operating security token offering (STO) investment products according to an embodiment of the present disclosure;

FIG. 2 is a hardware block diagram of a computing device that performs a method of determining a collateral ratio for liquidity risk management of STO investment products according to another embodiment of the present disclosure;

FIG. 3 is a flowchart of a method of determining a collateral ratio for liquidity risk management of STO investment products according to still another embodiment of the present disclosure; and

FIG. 4 is a flowchart for describing a method of determining asset liquidity risk in various embodiments.

### DETAILED DESCRIPTION OF EXEMPLARY EMBODIMENTS

Various advantages and features of the present disclosure and methods accomplishing them will become apparent from the following description of embodiments with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims.

Terms used in the present specification are for explaining embodiments rather than limiting the present disclosure. Unless explicitly described to the contrary, a singular form includes a plural form in the present specification. Terms “comprise” and/or “comprising” used in the present disclosure do not exclude the existence or addition of one or more other components other than the mentioned components.

Like reference numerals refer to like components throughout the specification and “and/or” includes each of the components mentioned and includes all combinations thereof. The terms “first,” “second” and the like are used to describe various components, but these components are not limited by these terms. These terms are used only in order to distinguish one component from other components. Therefore, it goes without saying that the first component mentioned below may be the second component within the technical scope of the present disclosure.

Further, as used herein, the term “unit” or “module” means a hardware component such as software, a field programmable gate array (FPGA), or an application specific integrated circuit (ASIC) and performs predetermined functions. However, the term “unit” or “module” is not meant to be limited to software or hardware. A “unit” or “module” may be stored in a storage medium that can be addressed or may be configured to regenerate one or more processors. Accordingly, for example, the “unit” or “module” includes components such as software components, object-oriented software components, class components, and task components, processors, functions, attributes, procedures, subroutines, segments of a program code, drivers, firmware, a microcode, a circuit, data, a database, data structures, tables, arrays, and variables. Functions provided in components, “units,” or “modules” may be combined into fewer components, “units,” or “modules” or further separated into additional components, “units,” or “modules.”

Spatially relative terms “below,” “beneath,” “lower,” “above,” “upper,” and the like, may be used in order to easily describe correlations between one component and other components. The spatially relative terms should be understood as terms including different directions of components during use or operation in addition to the directions illustrated in the drawings. For example, in a case of overturning component illustrated in the drawings, a component described as “below” or “beneath” another component may be placed “above” the other component. Accordingly, an illustrative term “below” may include both of a downward direction and an upward direction. Components may be oriented in other directions as well, and thus, spatially relative terms may be interpreted according to orientations.

Unless the context dictates otherwise, as used herein, the expressions such as “first,” “second,” or “1^{st}” or “2^{nd}” are used to distinguish one object from another when referring to a plurality of objects of the same type and do not limit the order or importance of the objects in question.

As used herein, the expressions “A, B, and C,” “A, B, or C,” “A, B, and/or C,” “at least one of A, B, and C,” “at least one of A, B, or C,” “at least one of A, B, and/or C,” “at least one selected from A, B, and C,” “at least one selected from A, B, or C,” “at least one selected from A, B, and/or C,” etc., may mean each of the listed items or all possible combinations of the listed items. For example, “at least one selected from A and B” may refer to (1) A, (2) at least one of A, (3) B, (4) at least one of B, (5) at least one of A and at least one of B, (6) at least one of A and B, (7) at least one of B and A, (8) both A and B.

As used herein, the expression “˜based on” is used to describe one or more factors affecting the decision, act of judgment, or action described in the phrase or sentence containing the expression, and this expression does not exclude additional factors influencing the decision, or act or action of judgment.

As used herein, the expression “a component (e.g., a first component) is “connected” or “coupled” to another component (e.g., a second component)” may mean that the component is not only directly connected or coupled to another component, but is also connected or coupled to another component via a new another component (e.g., a third component).

As used herein, the expression “configured to” may mean “set to,” “have the ability to,” “modified to,” “made to,” “capable of,” etc., according to the context. The corresponding expression is not limited to the meaning of “specifically designed in hardware”. For example, a processor configured to perform a specific operation may mean a generic-purpose processor that can perform the specific operation by executing software.

Unless defined otherwise, all terms (including technical and scientific terms) used in the present specification have the same meanings commonly understood by those skilled in the art to which the present disclosure pertains. In addition, terms defined in generally used dictionaries are not ideally or excessively interpreted unless they are specifically defined clearly.

In this specification, a computer means all kinds of hardware devices including at least one processor and can be understood as including a software configuration which is operated in the corresponding hardware device according to the embodiment. For example, the computer may be understood as a meaning including all of smart phones, tablet PCs, desktops, laptops, and user clients and applications running on each device, but is not limited thereto.

Hereinafter, embodiments of the present disclosure will be described in detail with reference to the accompanying drawings.

Each step described in this specification is described as being performed by the computer, but subjects of each step are not limited thereto, and according to embodiments, at least some of each step can also be performed on different devices.

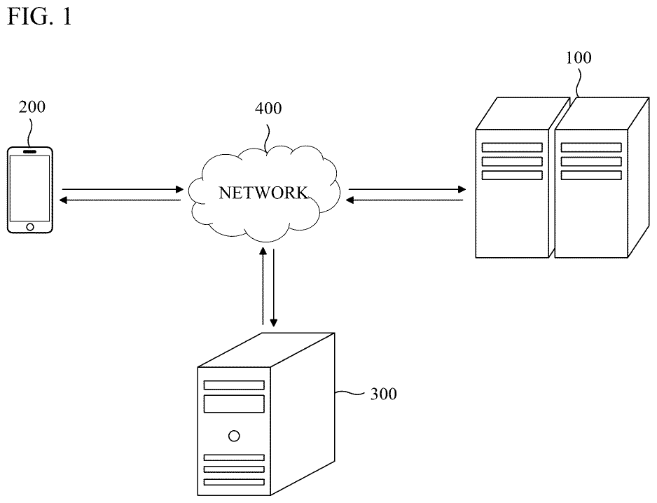

FIG. 1 is a diagram illustrating a system for operating security token offering (STO) investment products according to an embodiment of the present disclosure.

Referring to FIG. 1, the system for operating STO investment products according to an embodiment of the present disclosure may include a computing device 100, a user terminal 200, an external server 300, and a network 400.

Here, the system for operating STO investment products illustrated in FIG. 1 is according to an embodiment, and components of the system for operating STO investment products are not limited to the embodiment illustrated in FIG. 1, and some components may be added, changed, or deleted as necessary.

In an embodiment, the computing device 100 may perform various operations necessary for operating the STO investment products as a central processing unit of the system for operating STO investment products.

For example, the computing device 100 may perform generation, management, and update of a smart contract related to issuance of the STO but is not limited thereto.

As another example, the computing device 100 may process procedures such as processing, dividend payment, and repayment for transaction requests obtained from investors, and may monitor and respond to liquidity risk and various market risks.

In various embodiments, the computing device 100 may determine a collateral ratio for investment products for the purpose of managing the liquidity risk of the STO investment products. For example, the computing device 100 may collect data related to the STO investment products, determine an asset liquidity risk of investment products based on the collected data, and determine the collateral ratio for the investment products based on the asset liquidity risk. However, the present disclosure is not limited thereto.

In various embodiments, the computing device 100 may be connected to the user terminal 200 via the network 400, and may provide various functions related to the STO investment products (e.g., fund deposit, investment product inquiry, transaction request, and investment product-related information guidance, etc.) to the user terminal 200 of a user (e.g., investor, manager of an operating company, professional liquidity provider, etc.).

Here, the user terminal 200 may refer to any type of entity(s) in the system that has a mechanism for communication with the computing device 100. For example, the user terminal 200 may include a personal computer (PC), a notebook, a mobile terminal, a smart phone, a tablet personal computer (tablet PC), a wearable device, etc., and may include all types of terminals that may access wired/wireless networks. In addition, the user terminal 200 may include any computing device implemented by at least one of an agent, an application programming interface (API), and a plug-in. In addition, the user terminal 200 may include an application source and/or a client application.

In addition, here, the network 400 may be a connection structure capable of exchanging information between respective nodes such as a plurality of terminals and servers. For example, the network 400 may include a local area network (LAN), a wide area network (WAN), the Internet (World Wide Web (WWW)), a wired/wireless data communication network, a telephone network, a wired/wireless television communication network, a controller area network (CAN), Ethernet, or the like.

Examples of the wireless data communication network may include 3G, 4G, 5G, 3rd Generation Partnership Project (3GPP), 5th Generation Partnership Project (5GPP), long term evolution (LTE), world interoperability for microwave access (WiMAX), Wi-Fi, Internet, a local area network (LAN), a wireless local area network (WLAN), a WAN, a personal area network (PAN), radio frequency (RF), a Bluetooth network, a near-field communication (NFC) network, a satellite broadcast network, an analog broadcast network, a digital multimedia broadcasting (DMB) network, and the like, but are not limited thereto.

In an embodiment, the external server 300 may be connected to the computing device 100 via the network 400, and may store and manage various types of information/data (e.g., the data related to the STO investment products) required for the computing device 100 to perform the method of determining a collateral ratio for liquidity risk management of STO investment products, or may collect, store, and manage various types of information/data (e.g., information on asset liquidity risk and collateral ratio for each investment product) generated as the computing device 100 performs the method of determining a collateral ratio for liquidity risk management of the STO investment products.

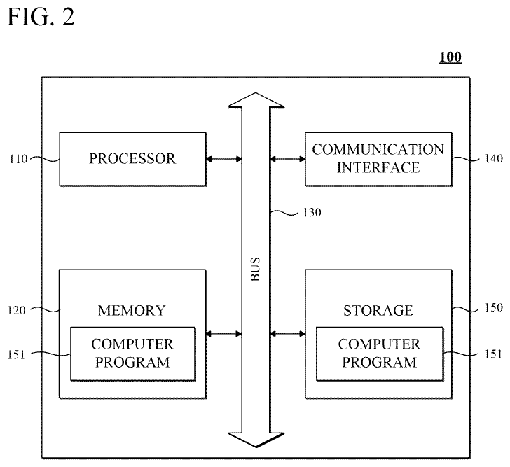

For example, the external server 300 may be a storage server separately provided outside the computing device 100 but is not limited thereto. Hereinafter, the hardware configuration of the computing device 100 that performs the method of determining a collateral ratio for liquidity risk management of STO investment products will be described with reference to FIG. 2.

FIG. 2 is a hardware block diagram of a computing device that performs a method of determining a collateral ratio for liquidity risk management of STO investment products according to another embodiment of the present disclosure.

Referring to FIG. 2, according to another embodiment of the present disclosure, the computing device 100 may include one or more processors 110, a memory 120 into which a computer program 151 executed by the processor 110 is loaded, a bus 130, a communication interface 140, and a storage 150 for storing the computer program 151. Here, only the components related to the embodiment of the present disclosure are illustrated in FIG. 2. Accordingly, a person skilled in the art to which the present disclosure pertains may know that other general-purpose components may further be included in addition to the components illustrated in FIG. 2.

The processor 110 controls an overall operation of each component of the computing device 100. The processor 110 may include a central processing unit (CPU), a micro processor unit (MPU), a micro controller unit (MCU), a graphics processing unit (GPU), or any type of processor well known in the art of the present disclosure.

In addition, the processor 110 may perform an operation on at least one application or program for executing the method according to the embodiments of the present disclosure, and the computing device 100 may include one or more processors.

In various embodiments, the processor 110 may further include a random access memory (RAM) (not illustrated) and a read-only memory (ROM) (not illustrated) for temporarily and/or permanently storing signals (or data) processed in the processor 110. In addition, the processor 110 may be implemented in the form of a system-on-chip (SoC) including at least one of a graphics processing unit, a RAM, and a ROM.

The memory 120 stores various data, commands, and/or information. The memory 120 may load the computer program 151 from the storage 150 to execute methods/operations according to various embodiments of the present disclosure. When the computer program 151 is loaded into the memory 120, the processor 110 may perform the method/operation by executing one or more instructions constituting the computer program 151. The memory 120 may be implemented as a volatile memory such as a RAM, but the technical scope of the present disclosure is not limited thereto.

The bus 130 provides a communication function between the components of computing device 100. The bus 130 may be implemented as various types of buses, such as an address bus, a data bus, and a control bus.

The communication interface 140 supports wired/wireless Internet communication of the computing device 100. In addition, the communication interface 140 may support various communication manners other than the Internet communication. To this end, the communication interface 140 may include a communication module well known in the art to which the present disclosure pertains. In some embodiments, the communication interface 140 may be omitted.

The storage 150 may non-temporarily store the computer program 151. When performing a collateral ratio determination process for the liquidity risk management of the STO investment products through the computing device 100, the storage 150 may store various types of information necessary to provide the collateral ratio determination process for the liquidity risk management of the STO investment products.

The storage 150 may include a non-volatile memory such as a ROM, an erasable programmable ROM (EPROM), an electrically erasable programmable ROM (EEPROM), or a flash memory, a hard disk, a removable disk, or any type of computer-readable recording medium well known in the art to which the present disclosure pertains.

The computer program 151 may include one or more instructions to cause the processor 110 to perform methods/operations according to various embodiments of the present disclosure when loaded into the memory 120. That is, the processor 110 may perform the method/operation according to various embodiments of the present disclosure by executing the one or more instructions.

In an embodiment, the computer program 151 may include one or more instructions that perform the method of determining a collateral ratio for liquidity risk management of STO investment products, in which the method includes collecting the data related to the STO investment products, determining the asset liquidity risk of the investment products based on the collected data, and determining the collateral ratio for the investment products based on the determined asset liquidity risk.

Operations of the method or algorithm described with reference to the embodiment of the present disclosure may be directly implemented in hardware, in software modules executed by hardware, or in a combination thereof. The software module may reside in a RAM, a ROM, an erasable programmable ROM (EPROM), an electrically erasable programmable ROM (EEPROM), a flash memory, a hard disk, a removable disk, a compact disc read-only memory (CD-ROM), or in any form of computer-readable recording media known in the art to which the present disclosure pertains.

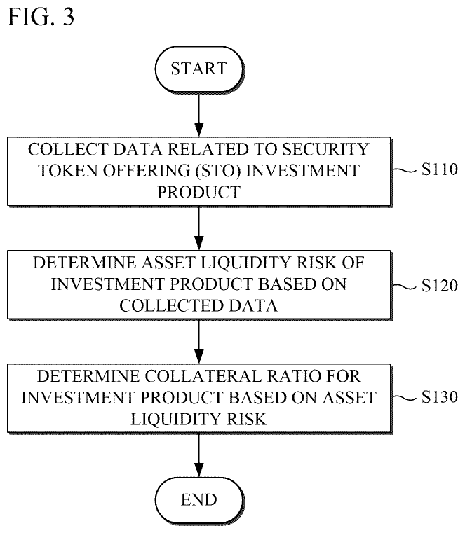

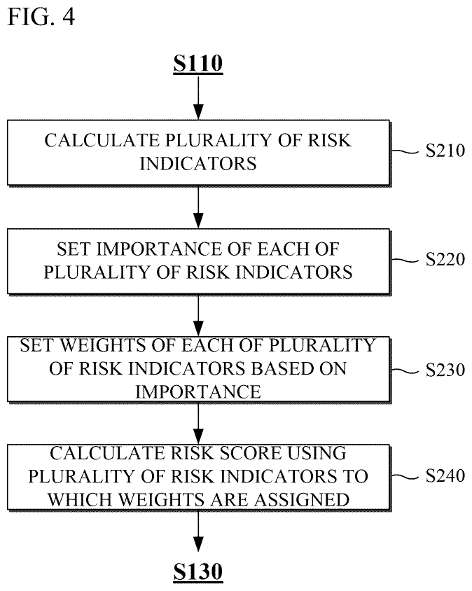

The components of the present disclosure may be embodied as a program (or application) and stored in media for execution in combination with a computer which is hardware. The components of the present disclosure may be executed in software programming or software elements, and similarly, embodiments may be realized in a programming or scripting language such as C, C++, Java, and assembler, including various algorithms implemented in a combination of data structures, processes, routines, or other programming constructions. Functional aspects may be implemented in algorithms executed on one or more processors. Hereinafter, the method of determining a collateral ratio for liquidity risk management of the STO investment products performed by a computing device 100 will be described in more detail with reference to FIGS. 3 and 4.

FIG. 3 is a flowchart of a method of determining a collateral ratio for liquidity risk management of STO investment products according to still another embodiment of the present disclosure.

Referring to FIG. 3, in operation S110, the computing device 100 may collect the data related to the STO investment products.

Here, the data related to the STO investment products may mean data that may be utilized to evaluate the asset liquidity risk of the STO investment products.

More specifically, first, the data related to the STO investment products may include market liquidity data (e.g., trading volume, bid/ask spread, market depth, etc.) obtained from an exchange API, a financial data provider, etc. In this case, the market liquidity data may be verified through a multi-source verification and data quality management system to ensure reliability but is not limited thereto.

Next, the data related to the STO investment products may include the asset liquidity data (e.g., asset transaction frequency, bid/ask balance, etc.) obtained from a transaction record database, etc. In this case, the asset liquidity data may be subject to backup database and data normalization to ensure reliability but is not limited thereto.

Next, the data related to the STO investment products may include credit risk data (e.g., credit rating, default probability, etc.) obtained from a credit rating agency, financial statements, a credit default swap (CDS) market, etc. In this case, the credit risk data may utilize public institution data to ensure reliability and may perform an internal verification procedure but is not limited thereto.

Next, the data related to the STO investment products may include market volatility data (e.g., historical volatility, implied volatility, etc.) obtained from price data, option market data, etc. Here, the market volatility data may be applied with an outlier removal algorithm to ensure reliability, and subject to periodic optimization of data update, but is not limited thereto.

Next, the data related to the STO investment products may obtain regulatory risk data (e.g., changes in laws and regulations, etc.) obtained from government and regulatory agency websites, legal advice, etc. In this case, the regulatory risk data may be subject to an automated legal monitoring system and multiple verification methods to ensure reliability but are not limited thereto.

Next, the data related to the STO investment products may include macroeconomic risk data (e.g., GDP growth rate, interest rate, exchange rate, etc.) obtained from official statistical agencies, international organizations, etc. In this case, the macroeconomic risk data may be subject to official announcement schedule management, data verification, and correction to ensure reliability, but are not limited thereto.

Next, the data related to the STO investment products may include correlation risk data (e.g., correlation between assets, etc.) obtained from asset data within a portfolio, etc. Here, statistical analysis and machine learning techniques may be applied to the correlation risk data to ensure reliability but are not limited thereto.

Finally, the data related to the STO investment products may include event risk data (e.g., corporate events, political/natural events, etc.) obtained from news articles, social media, corporate disclosures, etc. Here, natural language processing (NLP) technology and reliability evaluation procedures may be applied to the event risk data to ensure reliability but are not limited thereto.

Here, the types of data included in the data related to the STO investment products follow an embodiment, and are not limited thereto, and any information related to the STO investment products may be applied.

In operation S120, the computing device 100 may determine the asset liquidity risk of the investment products based on the data obtained through operation S110.

In various embodiments, the computing device 100 may calculate a risk score as the asset liquidity risk of the investment products based on the data related to the STO investment products. Hereinafter, a method of calculating a risk score will be described in more detail with reference to FIG. 4.

FIG. 4 is a flowchart for describing a method of determining asset liquidity risk in various embodiments.

Referring to FIG. 4, in operation S210, the computing device 100 may calculate a plurality of risk indicators based on the data related to the STO investment products.

In various embodiments, the computing device 100 may normalize each element included in the data related to the STO investment products to a value within a predetermined range (e.g., 0 to 1) and calculate a plurality of risk indicators by weight-averaging the normalized values.

Here, the plurality of risk indicators may include a market liquidity risk indicator L1, an asset liquidity risk indicator L2, a credit risk indicator CR, a market volatility risk indicator V, a regulatory risk indicator RR, a macroeconomic risk indicator MR, a correlation risk indicator Corr, and an event risk indicator ER.

First, the computing device 100 may calculate the market liquidity risk indicator L1. The computing device 100 may normalize each element included in the market liquidity data, such as the trading volume, bid/ask spread, and the market depth, and calculate a market liquidity risk score as the market liquidity risk indicator L1 by weight-averaging the normalized elements.

Here, the higher the trading volume, the narrower the bid/ask spread, and the deeper the market depth (the greater the remaining volume of pending bid/ask orders), the higher the asset liquidity. Therefore, as the trading volume is high, the bid/ask spread is narrow, and the market depth is deep, the market liquidity risk score may be designed to be calculated low, but the present disclosure is not limited thereto.

Next, the computing device 100 may calculate the asset liquidity risk indicator L2. The computing device 100 may normalize each element included in the asset liquidity data, such as the trading frequency and the bid/ask spread and calculate an asset liquidity risk score as the asset liquidity risk indicator L2 by weight-averaging the normalized elements.

Here, the higher the trading frequency and the larger the volume of pending bid/ask orders, the higher the asset liquidity. Therefore, as the trading frequency and the remaining amount of the bid/ask increase, the asset liquidity risk score may be designed to be calculated low, but the present disclosure is not limited thereto.

Next, the computing device 100 may calculate a credit risk indicator CR. The computing device 100 may normalize each element included in the credit risk data, such as the credit rating, the CDS spread, and the default probability, and calculate a credit risk score as the credit risk indicator CR by weight-averaging the normalized elements.

Here, as the credit rating decreases, the CDS spread of a specific company or asset increases, the default probability increases, and the credit risk score may be designed to be calculated high, but the present disclosure is not limited thereto.

Next, the computing device 100 may calculate the market volatility risk indicator V. The computing device 100 may normalize each element included in the market volatility data, such as past price volatility and implied volatility, and calculate a market volatility risk score as the market volatility risk indicator V by weight-averaging the normalized elements.

Here, as the price volatility increases and the implied volatility increases, the market volatility risk score may be designed to be calculated high, but the present disclosure is not limited thereto.

Next, the computing device 100 may calculate the regulatory risk indicator RR. The computing device 100 may normalize each element included in the regulatory risk data, such as regulatory change frequency, regulatory intensity, and legal risk information, and calculate a regulatory risk score as the regulatory risk indicator RR by weight-averaging the normalized elements.

Here, as the regulatory change frequency increases, the regulatory intensity increases, and the asset is more likely to have legal issues, the regulatory risk score may be designed to be calculated high, but the present disclosure is not limited thereto.

Next, the computing device 100 may calculate the macroeconomic risk indicator MR. The computing device 100 may normalize each element included in the macroeconomic risk data, such as GDP growth rate, interest rate fluctuation, exchange rate volatility, and inflation rate, and calculate a macroeconomic risk score as the macroeconomic risk indicator MR by weight-averaging the normalized elements.

Here, as the GDP growth rate decreases, the interest rate fluctuation increases, the exchange rate fluctuation increases, and the inflation increases, the macroeconomic risk score may be designed to be calculated high, but the present disclosure is not limited thereto.

Next, the computing device 100 may calculate the correlation risk indicator Corr. The computing device 100 may calculate the correlation risk score as the correlation risk indicator Corr based on the correlation coefficient between the assets included in the correlation risk data in the portfolio.

Here, the correlation coefficient between the assets in the portfolio may be measured, so as the correlation increases, the correlation risk score may be designed to be calculated high, but the present disclosure is not limited thereto.

Finally, the computing device 100 may calculate the event risk indicator ER. The computing device 100 may normalize each element included in the event risk data, such as news and political events and major public information, and calculate an event risk score as the event risk indicator ER by weight-averaging the normalized elements.

Here, when a political/economic event that may affect a specific asset occurs or when there is an important public announcement such as a major management change or performance announcement of a company, the event risk score may be designed to be calculated high, but the present disclosure is not limited thereto.

In various embodiments, the computing device 100 may calculate a plurality of risk indicators by analyzing the data related to the STO investment products through an artificial intelligence model.

Here, the artificial intelligence model may be a model trained according to a machine learning-based learning method based on training data that uses the data related to the STO investment products as input data and uses a plurality of risk indicators as correct data.

The artificial intelligence model (e.g. a neural network) is composed of one or more network functions, and one or more network functions may be composed of a set of interconnected computational units, which may generally be referred to as “node.” These “nodes” may also be referred to as “neurons.” One or more network functions include at least one or more nodes. Nodes (or neurons) that constitute one or more network functions may be interconnected by one or more “links.”

Within the artificial intelligence model, one or more nodes connected through the link may form a relative relationship between the input node and output node. The concepts of the input node and the output node are relative, and any node in the relationship of the output node with respect to one node may be in the input node relationship in the relationship with another node, and vice versa. As described above, the relationship between the input node and the output node may be generated around the link. One or more output nodes may be connected to one input node through the link, and vice versa.

In the relationship between the input node and the output node connected through one link, a value of the output node may be determined based on data input to the input node. Here, the link connecting between the input node and the output node may have weights. The weights may be variable and may vary by a user or algorithm in order for the artificial intelligence

model to perform the desired functions. For example, when one or more input nodes are connected to one output node by the respective links, the value of the output node may be determined based on the values input to the input nodes connected to the output node and the weights set on the links corresponding to the respective input nodes.

As described above, the artificial intelligence model interconnects one or more nodes through one or more links to form the relationship between the input node and the output node within the artificial intelligence model. The characteristics of the artificial intelligence model may be determined according to the number of nodes and links within the artificial intelligence model, the correlation between nodes and links, and the weight values assigned to each link. For example, if there are two artificial intelligence models with the same number of nodes and links and different weight values between the links, the two artificial intelligence models may be recognized as different from each other.

Some of the nodes constituting the artificial intelligence model may constitute one layer based on distances from an initial input node. For example, a set of nodes with a distance n from the initial input node may constitute n layers. The distance from the initial input node may be defined by the minimum number of links that should be passed to reach the corresponding node from the initial input node. However, this definition of the layer is arbitrary for explanation purposes, and the order of the layer within the artificial intelligence model may be defined in a different way than described above. For example, the layer of the nodes may be defined by a distance from a final output node.

The initial input nodes may refer to one or more nodes, to which data is directly input without going through links in relationships with other nodes, among the nodes in the artificial intelligence model. Alternatively, the initial input nodes may refer to nodes that do not have other input nodes connected by the link in the relationship between the nodes based on the link within the artificial intelligence model network. Similarly, the final output nodes may refer to one or more nodes that do not have the output node in the relationship with other nodes among the nodes in the artificial intelligence model. In addition, hidden nodes may refer to nodes that constitute the artificial intelligence model rather than the first input node and the last output node. The artificial intelligence model according to the embodiment of the present disclosure may have more nodes of the input layer than the nodes of the hidden layer close to the output layer and may be the artificial intelligence model in which the number of nodes decreases as it progresses from the input layer to the hidden layer.

The artificial intelligence model may include one or more hidden layers. The hidden node of the hidden layer may use an output of a previous layer and an output of surrounding hidden nodes as an input. The number of hidden nodes for each hidden layer may be the same or different. The number of nodes of the input layer may be determined based on the number of data fields of the input data and may be the same as or different from the number of hidden nodes. The input data input to the input layer may be calculated by the hidden node of the hidden layer and output by a fully connected layer (FCL) which is the output layer.

In various embodiments, the artificial intelligence model may be a deep learning model.

The deep learning model (e.g., a deep neural network (DNN)) may refer to the artificial intelligence model including a plurality of hidden layers in addition to an input layer and an output layer. It is possible to identify latent structures of data by using the deep neural network. That is, it is possible to identify the latent structures (e.g., what objects are in the photo, what the content and emotion of the text are, what the content and emotion of the audio are, etc.) of a photo, text, video, sound, or music.

The deep neural network may include a convolutional neural network (CNN), a recurrent neural network (RNN), an auto encoder, a generative adversarial network (GAN), a restricted Boltzmann machine (RBM), a deep belief network (DBN), a Q network, a U network, a Siamese network, and the like, but is not limited thereto.

In various embodiments, the network function may include the auto encoder. Here, the autoencoder may be a type of artificial neural network to output the output data similar to the input data.

The autoencoder may include at least one hidden layer, and an odd number of hidden layers may be disposed between the input and output layers. The number of nodes in each layer may be reduced from the number of nodes in the input layer to an intermediate layer called a bottleneck layer (encoding), and then also be scaled up and symmetrically scaled down from the bottleneck layer to the output layer (symmetrical to the input layer). Nodes of a dimension reduction layer and a dimension restoration layer may or may not be symmetrical. In addition, the autoencoder may perform nonlinear dimension reduction. The number of nodes in the input layer and the output layer may correspond to the number of sensors remaining after preprocessing the input data. In the auto encoder structure, the number of nodes in the hidden layer included in the encoder may have a structure that decreases as the distance from the input layer increases. When the number of nodes in the bottleneck layer (the layer with the fewest nodes located between the encoder and the decoder) is too small, a sufficient amount of information may not be transferred, and therefore, the number of nodes may be maintained at a certain number or more (e.g., more than half of the input layers, etc.).

In operation S220, the computing device 100 may set the importance corresponding to each of the plurality of risk indicators produced through operation S210.

In various embodiments, the computing device 100 may set the importance corresponding to each of the plurality of risk indicators based on the type of investment products and the owner of the investment products.

For example, when the type of investment products is a beneficiary certificate and the owner of the investment products is an STO company, the computing device 100 may set the importance of the credit risk indicator CR and the regulatory risk indicator RR to a first importance and set the importance of the remaining risk indicators to a second importance lower than the first importance.

In addition, when the type of investment products is the beneficiary certificate and the owner of the investment products is a third party, the computing device 100 may set the importance of the asset liquidity risk indicator L2, the credit risk indicator CR, and the regulatory risk indicator RR to the first importance, set the importance of the market liquidity risk indicator L1, the market volatility risk indicator V, and the macroeconomic risk indicator MR to the second importance lower than the first importance, and set the importance of the remaining correlation risk indicator Corr and the event risk indicator ER to a third importance lower than the second importance.

In addition, when the type of investment products is a trading site and the owner of the investment products is the STO company, the computing device 100 may set the importance of the market liquidity risk indicator L1, the asset liquidity risk indicator L2, and the market volatility risk indicator V to the first importance, set the credit risk indicator CR, the regulatory risk indicator RR, and the macroeconomic risk indicator MR to the second importance, and set the importance of the remaining correlation risk indicator Corr and the event risk indicator ER to the third importance.

In addition, when the type of investment products is the trading site and the owner of the investment products is the third party, the computing device 100 may set the market liquidity risk indicator L1 and the asset liquidity risk indicator L2 to the first importance, set the importance of the market volatility risk indicator V to the second importance, set the credit risk indicator CR and the regulatory risk indicator RR to the third importance, set the macroeconomic risk indicator MR to a fourth importance lower than the third importance, and set the importance of the remaining correlation risk indicator Corr and the event risk indicator ER to a fifth importance lower than the fourth importance.

In operation S230, the computing device 100 may set weights corresponding to each of the plurality of risk indicators based on the importance set through operation S220.

Here, the weights corresponding to each of the plurality of risk indicators may be set within a range where the risk score calculated through operation S240 described below has a score of 0 or more and 100 or less but is not limited thereto.

In various embodiments, the computing device 100 may assign a larger weight to a risk indicator with a higher importance among the plurality of risk indicators than to a risk indicator with a relatively lower importance.

For example, when the type of investment products is the beneficiary certificate and the owner of the investment products is the STO company, the credit risk indicator CR and the regulatory risk indicator RR set to the first importance may be set to a weight of 0.2, and the remaining risk indicators set to the second importance may be set to a weight of 0.1.

In addition, when the type of investment products is a beneficiary certificate and the owner of the investment products is the third party, the asset liquidity risk indicator L2, the credit risk indicator CR, and the regulatory risk indicator RR set to the first importance may be set to a weight of 0.2, the market liquidity risk indicator L1, the market volatility risk indicator V, and the macroeconomic risk indicator MR set to the second importance may be set to a weight of 0.1, and the remaining risk indicators set to the third importance may be set to a weight of 0.05.

In addition, when the type of investment products is the trading site and the owner of the investment products is the STO company, the market liquidity risk indicator L1, the asset liquidity risk indicator L2, and the market volatility risk indicator V set to the first importance may be set to a weight of 0.2, the credit risk indicator CR, the regulatory risk indicator RR, and the macroeconomic risk indicator MR set to the second importance may be set to a weight of 0.1, and the remaining risk indicators set to the third importance may be assigned a weight of 0.05.

In addition, when the type of investment products is the trading site and the owner of the investment products is the third party, the computing device 100 may assign a weight of 0.25 to the market liquidity risk indicator L1 and the asset liquidity risk indicator L2 set to the first importance, assign a weight of 0.2 to the market volatility risk indicator V set to the second importance, assign a weight of 0.1 to the credit risk indicator CR and the regulatory risk indicator RR set to the third importance, assign a weight of 0.05 to the macroeconomic risk indicator MR set to the fourth importance, and assign a weight of 0.025 to the remaining risk indicators set to the fifth importance.

These weights for each importance are examples to describe that risk indicators with high importance are set with higher weights than risk indicators with relatively low importance, and the values of the weights set according to the importance are not limited thereto.

In operation S240, the computing device 100 may calculate the risk score using a plurality of risk indicators to which the weights are set through operation S230.

In various embodiments, the computing device 100 may calculate the risk score by summing the plurality of risk indicators to which the weights are assigned.

In various embodiments, the computing device may calculate the risk score using the following Equation 2.

$$Risk Score ( R ) = {w}_{1} ( L 1 ) + {w}_{2} ( L 2 ) + {w}_{3} ( CR ) + {w}_{4} ( V ) + {w}_{5} ( RR ) + {w}_{6} ( MR ) + {w}_{7} ( Corr ) + {w}_{8} ( ER ) \qquad < Equation 2 >$$

Referring back to FIG. 3, in operation S130, the computing device 100 may determine the collateral ratio for the investment products based on the asset liquidity risk determined through operation S120.

In various embodiments, the computing device 100 may determine the collateral ratio for the investment products based on the risk score calculated based on the data related to the STO investment products.

In various embodiments, the computing device 100 may determine the collateral ratio

$$Collateral Ratio ( CR ) = α \cdot In ( R + 1 ) + β \qquad < Equation 1 >$$

Here, α may indicate a first constant value set in advance.

The first constant value α may be a parameter that determines the range of change in the collateral ratio according to the change in the risk score. The larger the first constant value, the greater the change in the collateral ratio even for a small change in the risk score, so the sensitivity may increase, and the smaller the first constant value, the less the change in the collateral ratio even for a change in the risk score, so the sensitivity may decrease.

In addition, β may indicate a second constant value set in advance.

The second constant value β may be a parameter that determines a basic collateral ratio and may be a parameter that determines the collateral ratio when the risk score is 0. The larger the second constant value, the higher the minimum collateral ratio, so the basic protection level may increase, and the smaller the second constant value, the lower the minimum collateral ratio, so the financial burden of investors may decrease.

In various embodiments, the computing device 100 may determine the collateral ratio for the investment products based on the minimum collateral ratio and the maximum collateral ratio set in advance.

Here, the minimum collateral ratio may be determined based on at least one of regulatory requirements, asset type-specific characteristics, market practices, industry standards, and risk management strategies.

First, for the regulatory requirements, financial regulatory authorities of each country or region provide guidelines or regulations on the minimum collateral ratio, and in order to comply with these regulatory requirements, the minimum collateral ratio may be set higher than or equal to the ratio provided by the relevant regulatory authority.

In addition, for the asset type-specific characteristics, in the case of assets with high volatility and low liquidity, i.e., high-risk assets, the minimum collateral ratio may be set high to prepare for risk, and in the case of stable assets such as government bonds or large-cap stocks, i.e., low-risk assets, the minimum collateral ratio may be set low to increase investor capital utilization.

Next, for the market practices and industry standards, the minimum collateral ratio may be set by referring to the collateral ratio generally applied in similar financial products or services and reflecting the recommendations of the International Organization of Securities Commissions (IOSCO), etc.

Finally, for the risk management strategy, the minimum collateral ratio may be determined by reflecting the stress test results, i.e., testing the stability of the system in various market scenarios. In addition, the minimum collateral ratio may be set by considering an internal risk tolerance, that is, a maximum loss level that can be tolerated according to the company's risk management policy.

In addition, the maximum collateral ratio may be determined based on at least one of the investor burden, the transaction activation strategy, the systemic risk prevention strategy, the regulation, and the legal restriction.

First, for the investor burden and the transaction activation, when the collateral ratio is excessively high, the investor's financial burden may increase, so transactions may be declined. Therefore, the maximum collateral ratio may be limited to a reasonable level to prevent the excessive collateral requirements, so the market liquidity may be maintained.

Next, for the prevention of the systemic risk, when the collateral ratio exceeds 100%, the leverage effect disappears, thereby reducing the investor's participation, which may lead to the decrease in the market liquidity. Therefore, the collateral ratio may be appropriately limited to encourage investors to invest in various assets in order to prevent market collapse and promote risk diversification.

Next, for the regulatory and legal restrictions, some countries may legally limit the maximum collateral ratio, so the maximum collateral ratio may be limited by reflecting the recommendations of the regulatory agencies to ensure the stability of the financial system in consideration of the financial stability.

In various embodiments, when the collateral ratio is determined based on the risk score corresponding to the investment products, the computing device 100 may update a smart contract that issues, trades, and manages the STO in the investment products.

In this case, the computing device 100 may provide investors of investment products with a notification (e.g., email, SMS, app push notification, etc.) corresponding to the collateral ratio determined based on the risk score corresponding to the investment products and the updated smart contract.

In various embodiments, the computing device 100 may allocate the assets of the liquidity pool to the investment products based on the collateral ratio determined based on the risk score corresponding to the investment products.

Here, the liquidity pool may be a pool composed of funds deposited from operating companies of the plurality of STO investment products, investors of the plurality of STO investment products, and a professional liquidity provider for the purpose of hedging the liquidity risk.

More specifically, the operating companies (STO companies) of the multiple STO investment products may deposit initial funds for the stability of the liquidity pool and may continuously reinvest a portion of the company's profits in the liquidity pool.

Investors may voluntarily deposit funds into the liquidity pool. In this case, a certain reward may be provided to induce the voluntary participation. For example, additional rewards may be provided (staked) when funds are deposited for a certain period of time, but the present disclosure is not limited thereto.

A professional liquidity provider acts as a market maker and may provide market liquidity by utilizing spreads or provide liquidity through a contract with an STO company.

A method of injecting funds into a liquidity pool may utilize a smart contract (for example, participants may deposit funds into a liquidity pool through a smart contract), and transparency may be secured by recording all fund flows on the blockchain.

The liquidity pool may be operated by an automated market maker (AMM). The price may be automatically determined according to the asset ratio of the liquidity pool through the price determination algorithm, and the transactions of buyers and sellers may be automatically matched.

In addition, the liquidity pool may compensate liquidity providers for a portion of the transaction fees, and issue and pay a separate token as compensation for the liquidity supply. For example, the computing device 100 may allocate the assets of the liquidity pool to the investment products in an asset size proportional to the collateral ratio for the investment products in response to the asset liquidity risk of the investment products.

As another example, the computing device 100 may determine the asset size to be allocated to the investment products based on the transaction size of the investment products, adjust the asset size to be allocated to the investment products based on the collateral ratio determined for the investment products, and allocate the assets of the liquidity pool in proportion to the corresponding asset size to the investment products in response to the asset liquidity risk of the investment products.

The above-described method of determining a collateral ratio for liquidity risk management of STO investment products has been described with reference to the flowchart illustrated in the drawings. For a simple description, the method of determining a collateral ratio for liquidity risk management of STO investment products has been described by showing a series of blocks, but the present disclosure is not limited to the order of the blocks, and some blocks may be performed in an order different from that shown and performed in the present specification or may be performed concurrently. In addition, new blocks not described in the present specification and drawings may be added, or some blocks may be deleted or changed.

According to various embodiments of the present disclosure, it is possible to analyze data related to the STO investment products to determine the asset liquidity risk of the investment products, dynamically determine and adjust the collateral ratio for the investment products based on the determination to prevent the liquidity problems that can occur when the investors request the mass selling, causing the investors to manage the risk of their investment assets more clearly to enable the relatively safe investment, and effectively managing the liquidity risk of the STO investment products to more efficiently perform the overall asset management.

The effects of the present disclosure are not limited to the above-described effects, and other effects that are not mentioned may be obviously understood by those skilled in the art from the following description.

Although exemplary embodiments of the present disclosure have been described with reference to the accompanying drawings, those skilled in the art to which the present disclosure belongs will appreciate that various modifications and alterations may be made without departing from the spirit or essential feature of the present disclosure. Therefore, it is to be understood that the exemplary embodiments described hereinabove are illustrative rather than being restrictive in all aspects.

What is claimed is:

1. A method of determining a collateral ratio for liquidity risk management of a security token offering (STO) investment product, which is performed by a computing device, the method comprising:
collecting data related to an STO investment product;
determining an asset liquidity risk of the investment product based on the collected data; and
determining the collateral ratio for the investment product based on the determined asset liquidity risk.

2. The method of claim 1, wherein the determining of the asset liquidity risk includes:
calculating a plurality of risk indicators based on the collected data; and
calculating a risk score as the asset liquidity risk based on the plurality of calculated risk indicators.

3. The method of claim 2, wherein the plurality of calculated risk indicators include at least one of a market liquidity risk indicator (L1), an asset liquidity risk indicator (L2), a credit risk indicator (CR), a market volatility risk indicator (V), a regulatory risk indicator (RR), a macroeconomic risk indicator (MR), a correlation risk indicator (Corr), and an event risk indicator (ER).

4. The method of claim 2, wherein the calculating of the risk score includes:
setting weights corresponding to each of the plurality of calculated risk indicators;
assigning the set weights to each of the plurality of calculated risk indicators; and
calculating the risk score by summing the plurality of risk indicators to which the weights are assigned.

5. The method of claim 4, wherein the setting of the weights includes:
setting importance corresponding to each of the plurality of risk indicators calculated based on a type of the investment product and an owner of the investment product; and
setting the weights corresponding to each of the plurality of calculated risk indicators based on the set importance.

6. The method of claim 2, wherein the determining of the collateral ratio includes determining the collateral ratio using the following Equation 1:
$$Collateral Ratio ( CR ) = α \cdot In ( R + 1 ) + β , \qquad < Equation 1 >$$
here, the α indicates a first constant value set in advance and determines a range of change in the collateral ratio according to a change in the risk score, the β indicates a second constant value set in advance and determines a basic collateral ratio, and the R indicates the calculated risk score.

7. The method of claim 1, wherein the determining of the collateral ratio includes determining the collateral ratio for the investment product based on a minimum collateral ratio and a maximum collateral ratio set in advance,
the minimum collateral ratio is determined based on at least one of regulatory requirements, asset type-specific characteristics, market practices, industry standards, and risk management strategies, and
the maximum collateral ratio is determined based on at least one of investor burden, transaction activation strategy, systemic risk prevention strategy, regulation, and legal restriction.

8. The method of claim 1, further comprising:
updating a smart contract that issues, trades, and manages the STO in the investment product according to the determined collateral ratio; and
providing a notification corresponding to the determined collateral ratio and the updated smart contract.

9. The method of claim 1, further comprising allocating an asset of a liquidity pool to the investment product based on the determined collateral ratio,
wherein the liquidity pool is a pool composed of funds deposited from operating companies of a plurality of STO investment products, investors of the plurality of STO investment products, and a professional liquidity provider for the purpose of hedging the liquidity risk.

10. The method of claim 9, wherein the allocating of the asset of the liquidity pool to the investment product includes:
determining an asset size to be allocated to the investment product based on a transaction size of the investment product;
correcting the determined asset size based on the determined collateral ratio; and
allocating the asset of the liquidity pool equivalent to the corrected asset size to the investment product in response to the asset liquidity risk of the investment product.

11. The method of claim 9, wherein the allocating of the asset of the liquidity pool to the investment product includes allocating, to the investment product, the asset of the liquidity pool equivalent to the size of the asset proportional to the determined collateral ratio at a predetermined ratio.

12. A computing device for performing a method of determining a collateral ratio for liquidity risk management of a security token offering (STO) investment product, the computing device comprising:
a processor;
a network interface;
a memory; and
a computer program loaded into the memory and executed by the processor,
wherein the computer program includes:
an instruction to collect data related to the STO investment product;
an instruction to determine an asset liquidity risk of the investment product based on the collected data; and
an instruction to determine the collateral ratio for the investment product based on the determined asset liquidity risk.

13. A computer-readable recording medium on which a computer program is recorded, wherein the computer program is coupled to a computing device to execute a method of determining a collateral ratio for liquidity risk management of a security token offering (STO) investment product, which includes:
collecting data related to the STO investment product;
determining an asset liquidity risk of the investment product based on the collected data; and
determining the collateral ratio for the investment product based on the determined asset liquidity risk.
